(19) United States
(12) Patent Application Publication
(10) Pub. No.: US 2023/0015095 A1
(43) Pub. Date: Jan. 19, 2023

(54) DATABASE INFORMATION BACKUP METHOD AND RECOVERY METHOD, ELECTRONIC DEVICE, AND COMPUTER READABLE STORAGE MEDIUM

(71) Applicant: Aishu Technology Corp., Minhang District, Shanghai (CN)

(72) Inventors: Kaiden Huang, Shanghai (CN); Ella HU, Shanghai (CN)

(21) Appl. No.: 17/773,185

(22) PCT Filed: Aug. 26, 2020
(86) PCT No.: PCT/CN2020/111175

§ 371 Date: Sep. 26, 2022

(30) Foreign Application Priority Data
Oct. 31, 2019 (CN) 201911054960.5

(51) Int. Cl. G06F 11/14

(52) U.S. Cl. CPC G06F 11/1458; G06F 11/1451; G06F 2201/84

(57) ABSTRACT

Provided are a database information backup method and recovery method, an electronic device, and a computer-readable storage medium. The backup method includes the following steps: a server receives a backup task instruction and mounts a storage volume to a client; the client receives the mounted storage volume and determines whether the backup task instruction is a full backup, and if so, the client starts a CDP thread, the client starts a VSS to create a volume shadow copy; the client determines whether the backup task instruction is a full backup, and if so, the client backs up valid data in the volume shadow copy, otherwise, the client backs up corresponding data in the volume shadow copy; the server creates a storage volume snapshot and a time point; and the server unloads a mapping mounted by the storage volume.

The present disclosure claims priority to Chinese Patent Application No. 201911054960.5 filed with the China National Intellectual Property Administration (CNIPA) on Oct. 31, 2019, the disclosure of which is incorporated herein by reference in its entirety.

### TECHNICAL FIELD

The present application relates to the field of computer information storage technology, for example, a database information backup and recovery method, an electronic device, and a computer-readable storage medium.

### BACKGROUND

With the development of science and technology, we have now entered an information era. Information can be described as the most valuable “commodity” currently. In the computer field, data is a carrier of the information, making the protection of data become a top priority.

A database backup refers to a process of backing up all or part of database application data to a storage medium so that an operation error of a database administrator or a system failure is prevented from causing a loss of data.

Regular backups of a Microsoft structured quest language (MSSQL) (a type of database) in the related art are implemented through a virtual device interface (VDI). An application program sends a backup instruction to the VDI, reads data from the VDI, and then sends the data to a server for storage. During a recovery, the same operations as operations of a backup need to be performed. The recovery consumes almost the same time as the backup. The backup and the recovery each have a relatively high recovery time objective (RTO).

Among MSSQL backup methods of backing up an MSSQL, how to effectively capture MSSQL native data and continuously back up data to the storage in a permanent increment manner, so as to implement a “lightening” recovery has become an urgent problem to be solved.

### SUMMARY

The present application provides a database information backup and recovery method, an electronic device, and a computer-readable storage medium.

The present application can be implemented by the technical schemes hereinafter.

A database information backup method is provided. The database information backup method includes the steps below.

In step S1, a server receives a backup task instruction and mounts a storage volume to a client.

In step S2, the client receives the mounted storage volume and determines whether the backup task instruction is a full backup; and step S3 is performed based on the determination result that the backup task instruction is the full backup, or step S4 is performed based on the determination result that the backup task instruction is not the full backup.

In step S3, the client starts a continuous data protection (CDP) thread.

In step S4, the client starts a volume shadow copy (VSS) service to create a volume shadow copy for a production volume of a database to be backed up.

In step S5, the client determines whether the backup task instruction is the full backup; and step S6 is performed based on the determination result that the backup task instruction is the full backup, or step S7 is performed based on the determination result that the backup task instruction is not the full backup;

In step S6, the client backs up valid data in the volume shadow copy to the storage volume.

In step S7, the client backs up a corresponding change data block in the volume shadow copy to the storage volume according to the change data block information of the production volume acquired by the CDP thread.

In step S8, the server creates a storage volume snapshot and a time point.

In step S9, the server unloads a mapping mounted by the storage volume.

A database information recovery method is provided. The database information recovery method is based on the preceding database information backup method and includes the steps below.

In step S101, a server receives a recovery task instruction and mounts a corresponding storage volume to a client.

In step S102, the client receives the corresponding mounted storage volume and mounts the storage volume to a specified mounting point.

In step S103, the client attaches a to-be-recovered database to a database server and verifies the database status.

An electronic device is provided. The electronic device includes a processor and a memory configured to store a program.

The program, when executed by the processor, causes the processor to perform the preceding database information backup method or perform the preceding database information recovery method.

A computer-readable storage medium is provided. The computer-readable storage medium stores computer-executable instructions which, when executed by a processor, causes the processor to perform the preceding database information backup method or perform the preceding database information recovery method.

### BRIEF DESCRIPTION OF DRAWINGS

FIG. 1 is a flowchart of database information backup according to the present application.

FIG. 2 is a flowchart of database information recovery according to the present application.

FIG. 3 is a diagram of a structural relationship according to the present application.

FIG. 4 is a diagram illustrating the structure of an electronic device according to the present application.

### DETAILED DESCRIPTION

The present application is described hereinafter in detail in conjunction with drawings and embodiments. The embodiments are implemented on the basis of the solution of the present application. Detailed embodiments and specific operation processes are given, but the scope of the present application is not limited to the embodiments hereinafter.

### Embodiment

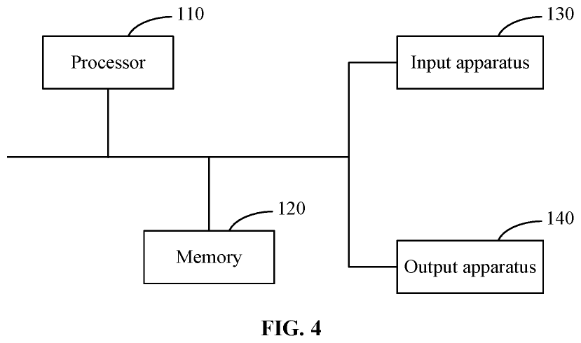

This embodiment takes an MSSQL database as an example to provide a database information backup method and a database information recovery method. The relationship of concepts involved is shown in FIG. 3.

As a data storage unit of backups, a storage medium is responsible for managing storage volumes, including creating a snapshot volume for a storage volume and creating a cloned volume by using the virtual cloning technology.

As a management console of the backups, a server is a management unit of the backups. The server undertakes the task of interacting with users and manages all resources, including storage media and client agents. Moreover, the server is responsible for issuing a backup task instruction or a recovery task instruction to a corresponding client agent and receiving the data and an execution result that are returned by the client agent. The server is further responsible for interacting with the storage media as well as reading and writing information data.

In this method, a client agent may be installed. As an agent of the backups on the client, the client agent is responsible for interacting with the server, receiving an instruction issued by the server, performing corresponding processing for the instruction, and returning the execution result to the server. The client agent here interacts with a database engine (DB engine) to perform an instance authentication, interacts with a volume shadow copy service (VSS) to create a volume shadow copy, and interacts with continuous data protection (CDP) to obtain incremental data and store the incremental data in the storage volume.

As a monitor of client data, the CDP is installed along with the installation of the client agent. The CDP maintains a block change bitmap internally. In the first backup, the CDP starts to monitor incremental data on a production volume in real time and synchronizes the incremental data to the internally maintained bitmap, ensuring that each backup is incremental data between the last backup and the current backup.

The DB engine, short for the database engine, is a core component of the database. The DB engine copies and receives an external structured query language (SQL) instruction, parses and executes the instruction, and returns an execution result.

A disk represents an actual data storage of the database and is responsible for providing data during the backups.

The volume shadow copy service (VSS) is responsible for the consistency of backup data. As a set of component object model (COM) interfaces, the VSS implements a framework that enables volume backup to be performed when an application program on a system continues to be written into the volume. The VSS includes the following parts: a writer, a provider, and a requester. In the process (which is a short period of about 10 seconds) of creating a volume shadow copy, the writer temporarily “freezes” the data writing of the application to ensure that the data is static and stable when the volume shadow copy is created. This embodiment uses this feature of the writer to guarantee the consistency of MSSQL data.

Native data is in a data format in which database files (for example, data files, secondary data files, and log files included in the MSSQL) of the database are stored on the disk.

The backup method and the recovery method are composed of a client and a server. The server includes a storage medium. The client is connected to the server through Ethernet by using the transmission protocols of transmission control protocol/Internet protocol (TCP/IP).

This embodiment may be implemented based on the premises below.
1. In a network backup system, the client agent and the server are in the same network and have mutual access permissions.
2. An operator has administrative permissions of the corresponding client agent.
3. The operator has permissions of using a storage medium of the corresponding server.
4. The operator configures information, such as a correct username and password, for an instance to be backed up.

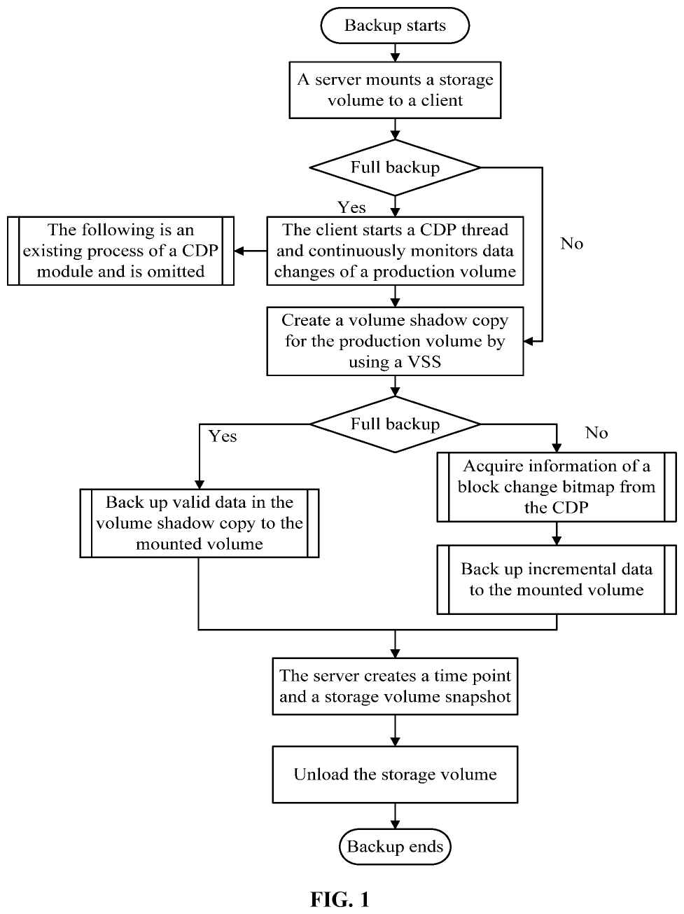

As shown in FIG. 1, a backup process is as below.

In 1, an operator selects a data source (database) to be protected, establishes a backup task, and initiates the backup task; and step 2 is performed.

In 2, a server receives a backup task instruction and mounts a storage volume to a client; and step 3 is performed.

In one embodiment, step 2 may include the steps below.

In 2.1, the server receives the backup task instruction and the backup task starts.

In 2.2, the server determines whether the backup task instruction is the first backup; and if so, step 2.3 is performed, otherwise, step 2.4 is performed.

In 2.3, the server creates the storage volume.

In 2.4, the server mounts the storage volume to the client.

In 3, the client receives the mounted storage volume and determines whether the backup task instruction is a full backup; and if so, step 4 is performed, otherwise, step 5 is performed.

In 4, the client starts a CDP thread. The client starts the CDP thread, sets a monitoring volume label of the database to be backed up, and continuously monitors data changes of the database to be backed up; and step 5 is performed.

In 5, the client starts a VSS to create a volume shadow copy for a production volume of the database to be backed up; and step 6 is performed.

In 6, the client determines whether the backup task instruction is the full backup; and if so, step 7 is performed, otherwise, step 8 is performed.

In 7, the client backs up valid data in the volume shadow copy to the storage volume; and step 9 is performed.

In one embodiment, step 7 may include the steps below.

In 7.1, the name of the volume shadow copy corresponding to the production volume to be backed up is acquired.

In 7.2, the client starts multithreading to back up the current production volume and backs up the valid data in the volume shadow copy to the storage volume.

In 7.3, it is detected whether the client still has a production volume to be backed up; and if so, steps 7.1 to 7.3 are repeated, otherwise, step 9 is performed.

In 8, the client backs up a corresponding change data block in the volume shadow copy to the storage volume according to the information (an offset and a length of the data block) about the change data block of the production volume acquired by the CDP thread; and step 9 is performed.

In one embodiment, step 8 may include the steps below.

In 8.1, the name of the volume shadow copy corresponding to the production volume to be backed up is acquired.

In 8.2, the client acquires the information (that is, incremental data) about change data blocks of all production volumes in the CDP thread and backs up the change data block corresponding to the volume shadow copy to the storage volume. The data consistency is guaranteed by backing up the corresponding data of the volume shadow copy.

In 8.3, the information about the change data block is cleared, and new information about a change data block is started to be recorded.

In 9, the server creates a time point, creates a storage volume snapshot for the storage volume, and retains a historical time point; and step 10 is performed.

In 10, the server unloads a mapping of the storage volume that is mapped to the client, and the backup ends.

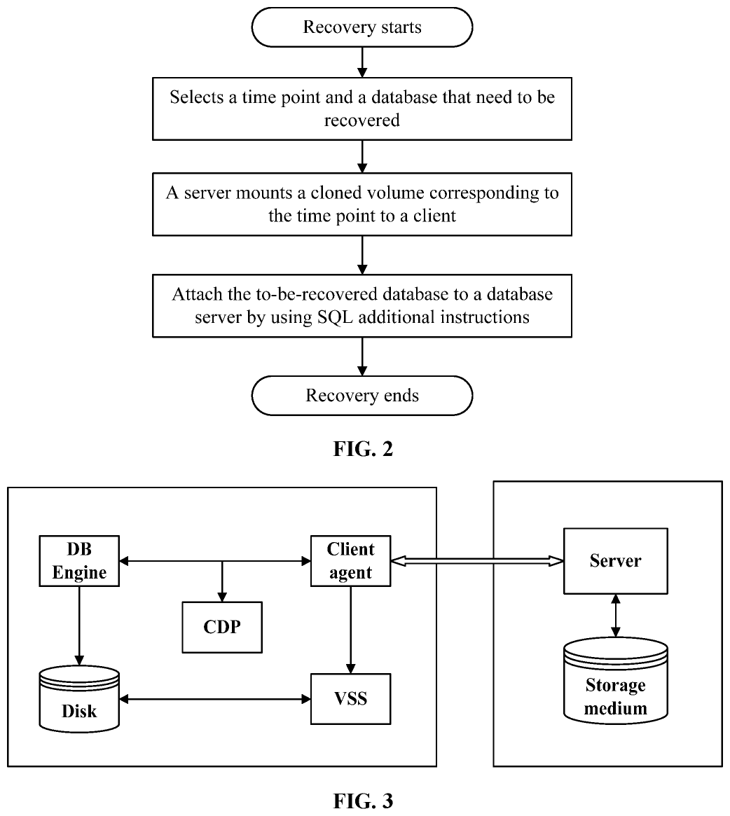

As shown in FIG. 2, a recovery process may be as below.

In 1001, an operator selects a time point and a database that need to be recovered, establishes and initiates a recovery task; and step 1002 is performed.

In 1002, the server receives a recovery task instruction and mounts a corresponding storage volume to the client; and step 1003 is performed.

In one embodiment, step 1002 may include the steps below.

In 1002.1, the server receives the recovery task instruction and creates a cloned volume for a storage volume snapshot of the corresponding storage volume.

In 1002.2, the server mounts the cloned volume to the client through the Internet small computer system interface (ISCSI) or fibre channel (FC) protocol.

In 1003, the client refreshes a corresponding link, finds the mounted storage volume, and mounts the storage volume to a specified mounting point; and step 1004 is performed.

In 1004, the client attaches the database to a database server through SQL sentences; and step 1005 is performed.

In one embodiment, step 1004 may include the steps below.

In 1004.1, the client finds all file paths of the to-be-recovered database from the cloned volume.

In 1004.2, the to-be-recovered database is attached to the database server by using SQL additional instructions.

In 1005, the status of the attached database is verified, and the recovery ends.

The effects below can be implemented through this method.

Through a combination of the CDP and the VSS, the backup mode of native data capture and permanent increment can be implemented. Moreover, in combination with the copy data management (CDM) technology of the server, data is merged incrementally, and snap shooting and virtual cloning are performed on the storage volume of the server. During the backup, the

VSS is used for creating the volume shadow copy of the production volume and backing up the data of the disk where database files are located. During the recovery, the cloned volume mounted to the client is a file system in the same data format as the original production volume. Only the database file paths need to be found and used as a parameter of the SQL additional instruction so as to attach the database to the target database server (that is, the database instance) rapidly, achieving a minute-level recovery, that is, a “lightning” recovery. In this way, requirements for a scenario with a low RTO and a low recovery point objective (RPO) are satisfied and the storage cost of the server can be saved.

FIG. 4 is a diagram illustrating the structure of hardware of an electronic device according to an embodiment. As shown in FIG. 4, the electronic device includes one or more processors 110 and a memory 120. One processor 110 is used as an example in FIG. 4.

The electronic device may further include an input apparatus 130 and an output apparatus 140.

The processor 110, the memory 120, the input apparatus 130, and the output apparatus 140 that are in the electronic device may be connected by a bus or in other manners. A connection by a bus is used as an example in FIG. 4.

As a computer-readable storage medium, the memory 120 may be configured to store software programs, computer-executable programs, and modules. The processor 110 runs the software programs, instructions and modules stored in the memory 120 to perform function applications and data processing, that is, to implement any method in the preceding embodiments.

The memory 120 may include a program storage region and a data storage region. The program storage region may store an operating system and an application program required by at least one function. The data storage region may store the data created according to the use of the electronic device. Additionally, the memory may include a volatile memory, for example, a random-access memory (RAM), and may also include a non-volatile memory, for example, at least one magnetic disk memory element, a flash memory element, or another non-transitory solid-state memory element.

The memory 120 may be a non-transitory computer storage medium or a transitory computer storage medium. The non-transitory computer storage medium includes, for example, at least a magnetic disk memory element, a flash memory element, or another non-volatile solid-state memory element. In some embodiments, the memory 120 may include memories which are disposed remotely relative to the processor 110. These remote memories may be connected to the electronic device via a network. The examples of the preceding network may include the

Internet, an intranet, a local area network, a mobile communication network, and a combination thereof.

The input apparatus 130 may be configured to receive the input digital or character information and generate key signal input related to user settings and function control of the electronic device. The output apparatus 140 may include a display device, for example, a display screen.

This embodiment further provides a computer-readable storage medium storing computer-executable instructions for executing the preceding methods.

All or part of the procedure processes in the methods of the preceding embodiments may be implemented by related hardware executed by computer programs, these programs may be stored in a non-transitory computer-readable storage medium, and during the execution of these programs, the processes in the preceding method embodiments may be implemented. The non-transitory computer-readable storage medium may be a magnetic disk, an optical disk, a read-only memory (ROM), or a RAM.

Compared with the related art, the present application has the advantages below.

(1) With the adoption of the CDP and VSS technology, a Windows application programming interface (API) is directly used for reading and writing native data of the database files instead of acquiring data from a VDI of the MSSQL so that the MSSQL native data can be effectively captured and the reading is fast and not easy to go wrong.

(2) Bitmap information of incremental data can be acquired by using the CDP technology, the permanent increment can be implemented and the storage cost of the server is saved.

(3) When the VSS is used for generating a volume shadow copy, data can be temporarily frozen, and the consistency of MSSQL data can be guaranteed.

(4) By combining the native data capture and the permanent increment with the copy data management (CDM) technology (through which the cloned volume and the storage volume snapshot can be generated) of the server, the “lightening” recovery of the database can be implemented, reducing the RTO effectively.

1. A database information backup method, comprising the following steps:
step S1: receiving, by a server, a backup task instruction, and mounting a storage volume to a client;
step S2: receiving, by the client, the mounted storage volume, determining whether the backup task instruction is a full backup, and performing step S3 based on a determination result that the backup task instruction is the full backup, or performing step S4 based on a determination result that the backup task instruction is not the full backup;
step S3: starting, by the client, a continuous data protection (CDP) thread;
step S4: starting, by the client, a volume shadow copy service (VS S) to create a volume shadow copy for a production volume of a database to be backed up;
step S5: determining, by the client, whether the backup task instruction is the full backup, and performing step S6 based on the determination result that the backup task instruction is the full backup, or performing step S7 based on the determination result that the backup task instruction is not the full backup;
step S6: backing up, by the client, valid data in the volume shadow copy to the storage volume;
step S7: backing up, by the client, a corresponding change data block in the volume shadow copy to the storage volume according to information about the change data block of the production volume acquired by the CDP thread;
step S8: creating, by the server, a storage volume snapshot and a time point; and
step S9: unloading, by the server, a mapping mounted by the storage volume.

2. The method according to claim 1, wherein step Si comprises:
step S11: receiving, by the server, the backup task instruction, and starting a backup task; step S12: determining, by the server, whether the backup task instruction is a first backup, and performing step S13 based on a determination result that the backup task instruction is the first backup, or performing step S14 based on a determination result that the backup task instruction is not the first backup;
step S13: creating, by the server, the storage volume; and
step S14: mounting, by the server, the storage volume to the client.

3. The method according to claim 1, wherein step S3 comprises:
starting, by the client, the CDP thread, setting a monitoring volume label of the database to be backed up, and continuously monitoring data changes of the database to be backed up.

4. The method according to claim 1, wherein step S6 comprises:
step S61: acquiring a name of the volume shadow copy corresponding to the production volume of the database to be backed up;
step S62: backing up, by the client, the valid data in the volume shadow copy to the storage volume; and
step S63: detecting whether the client still has a production volume to be backed up in the database to be back up, and repeating steps S61 to S63 based on a detection result that the client still has the production volume to be backed up, or performing step S8 based on a detection result that the client has no production volume to be backed up.

5. The method according to claim 1, wherein step S7 comprises:
step S71: acquiring a name of a volume shadow copy corresponding to a-the production volume of the database to be backed up;
step S72: backing up, by the client, the corresponding change data block in the volume shadow copy to the storage volume according to the information about the change data block of the production volume acquired by the CDP thread; and
step S73: clearing incremental data of the CDP thread.

6. A database information recovery method, the method being based on the database information backup method according to claim 1 and comprising the following steps:
step S101: receiving, by the server, a recovery task instruction, and mounting a corresponding storage volume to the client;
step S102: receiving, by the client, the corresponding mounted storage volume, and mounting the storage volume to a specified mounting point; and
step S103: attaching, by the client, a to-be-recovered database to a database server, and verifying a database status.

7. The method according to claim 6, wherein step S101 comprises:
step S1011: receiving, by the server, the recovery task instruction, and creating a cloned volume for a storage volume snapshot of the corresponding storage volume; and
step S1012: mounting, by the server, the corresponding cloned volume to the client.

8. The method according to claim 7, wherein in step S103, a process of attaching, by the client, the to-be-recovered database to the database server comprises:
finding, by the client, a path of the to-be-recovered database from the cloned volume; and
attaching the to-be-recovered database to the database server.

9. An electronic device, comprising:
a processor; and
a memory configured to store a program, wherein the program, when executed by the processor, causes the processor to perform the following steps:
step S1: receiving, by a server, a backup task instruction, and mounting a storage volume to a client:
step S2: receiving, by the client, the mounted storage volume, determining whether the backup task instruction is a full backup, and performing step S3 based on a determination result that the backup task instruction is the full backup, or performing step S4 based on a determination result that the backup task instruction is not the full backup;
step S3: starting, by the client, a continuous data protection (CDP) thread;
step S4: starting, by the client, a volume shadow copy service (VSS) to create a volume shadow copy for a production volume of a database to be backed up;
step S5: determining, by the client, whether the backup task instruction is the full backup, and performing step S6 based on the determination result that the backup task instruction is the full backup, or performing step S7 based on the determination result that the backup task instruction is not the full backup;
step S6: backing up, by the client, valid data in the volume shadow copy to the storage volume;
step S7: backing up, by the client, a corresponding change data block in the volume shadow copy to the storage volume according to information about the change data block of the production volume acquired by the CDP thread;
step S8: creating, by the server, a storage volume snapshot and a time point; and
step S9: unloading, by the server, a mapping mounted by the storage volume

10. A non-transitory computer-readable storage medium for storing computer-executable instructions which, when executed by a processor, causes the processor to perform the following steps:
step S1: receiving, by a server, a backup task instruction, and mounting a storage volume to a client:
step S2: receiving, by the client, the mounted storage volume, determining whether the backup task instruction is a full backup, and performing step S3 based on a determination result that the backup task instruction is the full backup, or performing step S4 based on a determination result that the backup task instruction is not the full backup;
step S3: starting, by the client, a continuous data protection (CDP) thread;
step S4: starting, by the client, a volume shadow copy service (VSS) to create a volume shadow copy for a production volume of a database to be backed up;
step S5: determining, by the client, whether the backup task instruction is the full backup, and performing step S6 based on the determination result that the backup task instruction is the full backup, or performing step S7 based on the determination result that the backup task instruction is not the full backup;
step S6: backing up, by the client, valid data in the volume shadow copy to the storage volume;
step S7: backing up, by the client, a corresponding change data block in the volume shadow copy to the storage volume according to information about the change data block of the production volume acquired by the CDP thread;
step S8: creating, by the server, a storage volume snapshot and a time point and step S9: unloading, by the server, a mapping mounted by the storage volume,

11. The electronic device according to claim 9, wherein the program causes the processor to perform step S1 by:
step S11: receiving, by the server, the backup task instruction, and starting a backup task;
step S12: determining, by the server, whether the backup task instruction is a first backup, and performing step S13 based on a determination result that the backup task instruction is the first backup, or performing step S14 based on a determination result that the backup task instruction is not the first backup;
step S13: creating, by the server, the storage volume; and
step S14: mounting, by the server, the storage volume to the client.

12. The electronic device according to claim 9, wherein the program causes the processor to perform step S3 by:
starting, by the client, the CDP thread, setting a monitoring volume label of the database to be backed up, and continuously monitoring data changes of the database to be backed up.

13. The electronic device according to claim 9, wherein the program causes the processor to perform step S6 by:
step S61: acquiring a name of the volume shadow copy corresponding to the production volume of the database to be backed up;
step S62: backing up, by the client, the valid data in the volume shadow copy to the storage volume; and
step S63: detecting whether the client still has a production volume to be backed up in the database to be back up, and repeating steps S61 to S63 based on a detection result that the client still has the production volume to be backed up, or performing step S8 based on a detection result that the client has no production volume to be backed up.

14. The electronic device according to claim 9, wherein the program causes the processor to perform step S7 by:
step S71: acquiring a name of the volume shadow copy corresponding to the production volume of the database to be backed up;
step S72: backing up, by the client, the corresponding change data block in the volume shadow copy to the storage volume according to the information about the change data block of the production volume acquired by the CDP thread; and
step S73: clearing incremental data of the CDP thread.

15. An electronic device, comprising:
a processor; and
a memory configured to store a program, wherein the program, when executed by the processor, causes the processor to perform the database information recovery method according to claim 6.

16. The storage medium according to claim 10, wherein the computer-executable instructions cause the processor to perform step S1 by:
step S11: receiving, by the server, the backup task instruction, and starting a backup task;
step S12: determining, by the server, whether the backup task instruction is a first backup, and performing step S13 based on a determination result that the backup task instruction is the first backup, or performing step S14 based on a determination result that the backup task instruction is not the first backup;
step S13: creating, by the server, the storage volume; and
step S14: mounting, by the server, the storage volume to the client.

17. The storage medium according to claim 10, wherein the computer-executable instructions cause the processor to perform step S3 by:
starting, by the client, the CDP thread, setting a monitoring volume label of the database to be backed up, and continuously monitoring data changes of the database to be backed up.

18. The storage medium according to claim 10, wherein the computer-executable instructions cause the processor to perform step S6 by:
step S61: acquiring a name of the volume shadow copy corresponding to the production volume of the database to be backed up;
step S62: backing up, by the client, the valid data in the volume shadow copy to the storage volume; and
step S63: detecting whether the client still has a production volume to be backed up in the database to be back up, and repeating steps S61 to S63 based on a detection result that the client still has the production volume to be backed up, or performing step S8 based on a detection result that the client has no production volume to be backed up.

19. The storage medium according to claim 10, wherein the computer-executable instructions cause the processor to perform step S7 by:
step S71: acquiring a name of the volume shadow copy corresponding to the production volume of the database to be backed up;
step S72: backing up, by the client, the corresponding change data block in the volume shadow copy to the storage volume according to the information about the change data block of the production volume acquired by the CDP thread; and
step S73: clearing incremental data of the CDP thread.

20. A non-transitory computer-readable storage medium for storing computer-executable instructions which, when executed by a processor, causes the processor to perform the database information recovery method according to claim 6.
